(19) United States
(12) Patent Application Publication
(10) Pub. No.: US 2016/0283457 A1
(43) Pub. Date: Sep. 29, 2016

(54) FORM FILLING USING A DATA MARK

(71) Applicant: INTERNATIONAL BUSINESS MACHINES CORPORATION, Armonk, NY (US)

(72) Inventors: Tara Astigarraga, Fairport, NY (US); Robin L. Elaiho, Tucson, AZ (US); Agueda M. H. Magro, Zapopan (MX); Jose R. M. Mejia, Puruandiro (MX)

(21) Appl. No.: 14/668,619

(22) Filed: Mar. 25, 2015

(51) Int. Cl. G06F 17/24; G06F 3/0484; G06F 21/62; G06F 17/22

(52) U.S. Cl. CPC G06F 17/243; G06F 17/22; G06F 3/04842; G06F 21/6209

(57) ABSTRACT

An apparatus, method, system, and program product are disclosed for creating a data mark. An input detection module detects input types and user inputs on a form of an application in response to receiving an indication to create a data mark. Each input type may correspond to a respective user input. A user selection module receives user selected input types that are to be stored in the data mark with their respective user inputs. A data mark creation module stores the data mark including the user selected input types with their respective user inputs.

### FIELD

The subject matter disclosed herein relates to forms and more particularly relates to form filling using a data mark.

### BACKGROUND

In many applications and websites forms are used for data entry. For example, forms may be used for entering customer data, entering order data, and entering customer service data. The forms may include multiple input types relating to data entry to be made by a user of the application or website.

### BRIEF SUMMARY

An apparatus for creating a data mark is disclosed. A method and computer program product also perform the functions of the apparatus. In one embodiment, an apparatus includes an input detection module that detects input types and user inputs on a form of an application in response to receiving an indication to create a data mark. In one embodiment, each input type corresponds to a respective user input. The apparatus, in a further embodiment, includes a user selection module that receives user selected input types that are to be stored in the data mark with their respective user inputs. In various embodiment, the apparatus includes a data mark creation module that stores the data mark including the user selected input types with their respective user inputs.

A method for creating a data mark, in one embodiment, includes receiving an indication to create a data mark corresponding to a form of an application. The method may also include detecting input types and user inputs on the form of the application in response to receiving the indication to create the data mark. In one embodiment, each input type corresponds to a respective user input. The method may include receiving user selected input types that are to be stored in the data mark with their respective user inputs. The method may also include storing the data mark including the user selected input types with their respective user inputs.

In one embodiment, a computer program product for creating a data mark includes a computer readable storage medium having program instructions embodied therewith. The program instructions, in some embodiments, are readable/executable by a processor to cause the processor to receive, by processor, an indication to create a data mark corresponding to a form of an application. The program instructions, in one embodiment, are readable/executable by a processor to cause the processor to detect, by processor, input types and user inputs on the form of the application in response to receiving the indication to create the data mark. In one embodiment, each input type corresponds to a respective user input. In a further embodiment, the program instructions are readable/executable by a processor to cause the processor to receive, by processor, user selected input types that are to be stored in the data mark with their respective user inputs. In various embodiments, the program instructions are readable/executable by a processor to cause the processor to store, by processor, the data mark including the user selected input types with their respective user inputs.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for creating a data mark in accordance with one embodiment of the present invention;

FIG. 2 is a schematic block diagram illustrating one embodiment of a module for creating a data mark in accordance with one embodiment of the present invention;

FIG. 3 is a schematic block diagram illustrating one embodiment of another module for creating a data mark in accordance with one embodiment of the present invention;

FIG. 4 is a schematic flow chart diagram illustrating one embodiment of a method for creating a data mark in accordance with one embodiment of the present invention;

FIG. 5 is a schematic flow chart diagram illustrating one embodiment of another method for creating a data mark in accordance with one embodiment of the present invention;

FIG. 6 illustrates one embodiment of an application for creating a data mark in accordance with one embodiment of the present invention; and

FIG. 7 is a schematic flow chart diagram illustrating one embodiment of a method for populating a form using a data mark in accordance with one embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

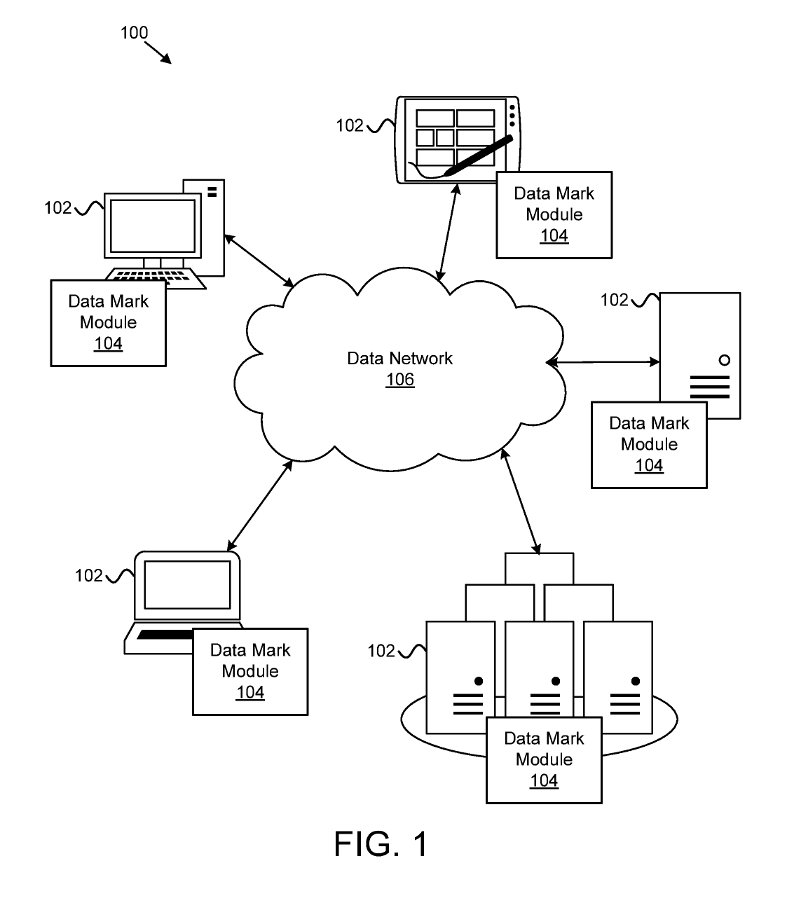

FIG. 1 depicts one embodiment of a system 100 for creating a data mark. In one embodiment, the system 100 includes information handling devices 102, data mark modules 104, and networks 106. Even though a particular number of information handling devices 102, data mark modules 104, and networks 106 are depicted in the system 100 of FIG. 1, one of skill in the art will recognize that any number or configuration of information handling devices 102, data mark modules 104, and networks 106 may be present in the system 100.

The information handling devices 102, in certain embodiments, include computing devices, such as desktop computers, laptop computers, tablet computers, smart phones, smart televisions, or the like. The information handling devices 102 may also include servers, such as web servers, application servers, file servers, media servers, email servers, cloud servers, backup servers, virtual servers, or the like. In some embodiments, the information handling devices 102 may be part of a data center used for data storage, data backup, data replication, disaster recovery, and/or the like. The information handling devices 102 may be located in geographically remote locations, in the same geographic location (e.g., the same data center), or some combination of both.

The information handling devices 102 may be configured to store data, backup data, replicate data, or the like. For example, the information handling devices 102 may be configured to perform synchronous or asynchronous data replication. In another example, information handling devices 102 may be configured as failover devices for one or more associated with production information handling devices 102. Moreover, the information handling devices 102 may comprise one or more storage volumes, storage devices, RAID devices or configurations, or the like, such as hard-disk drives, solid-state drives, flash memory devices, random-access memory (RAM), SATA devices, tape devices, or the like. In some embodiments, the information handling devices 102 are in communication via one or more data networks 106, described below.

In one embodiment, the data mark module 104 detects input types and user inputs on a form of an application in response to receiving an indication to create a data mark. The detected input types may be the fields or objects of a form that define the type of data that a user inputs in to the form. For example, the detected input types may include name, address, phone number, operating system, problem type, problem description, defect type, defect identification, serial number, release number, profile, or the like. The user inputs on the form may be the data that a user enters into the form. As may be appreciated, each input type corresponds to a respective user input. As used herein, a data mark includes a collection of data used to populate a specific form in an application.

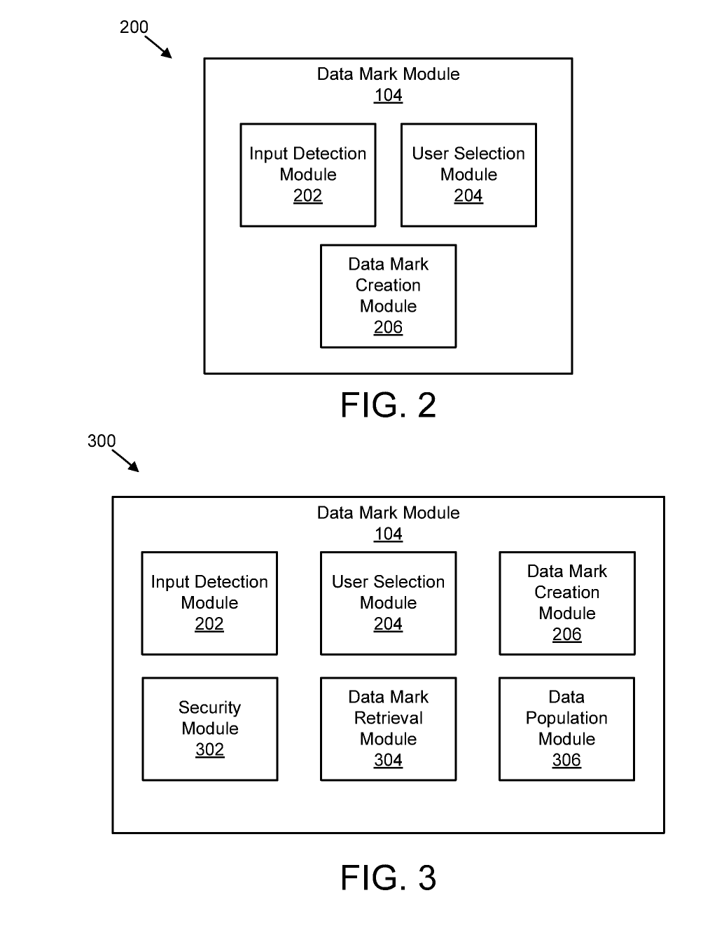

The data mark module 104 receives user selected input types that are to be stored in the data mark with their respective user inputs. The data mark module 104 may also store the data mark that includes the user selected input types with their respective user inputs. In this manner, the data mark module 104 may create the data mark that may be used to repetitively populate a form using the saved information, otherwise a user may have to type the information into the form each time the form uses the same saved information. Ultimately, this may allow customer service, problem reporting, data entry, or the like situations to occur faster and more efficiently. In certain embodiments, as described below with reference to FIGS. 2 and 3, the data mark module 104 includes multiple modules that perform the operations of the data mark module 104.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, random access memory (RAM), or the like.

FIG. 2 is a schematic block diagram illustrating one embodiment of a module 200 for creating a data mark. In one embodiment, the module 200 includes an embodiment of a data mark module 104. The data mark module 104, in various embodiment, includes one or more of an input detection module 202, a user selection module 204, and a data mark creation module 206, which are described in more detail below.

In one embodiment, the input detection module 202 detects input types and user inputs on a form of an application in response to receiving an indication to create a data mark. As described above, the detected input types may be the fields or objects of a form that define the type of data that a user inputs in to the form. For example, the detected input types may include name, address, phone number, operating system, problem type, problem description, defect type, defect identification, serial number, release number, profile, or the like. Moreover, the user inputs on the form may be the data that a user enters into the form to fill out the form. As may be appreciated, each input type corresponds to a respective user input. For example, an input type may be “Name” and the respective user input may be “John Doe.” The information “John Doe” represents data that a user enters into the form for the input type “Name.”

In certain embodiments, the input detection module 202 may define a name for the data mark. For example, the input detection module 202 may define a name for the data mark based on a uniform resource locator (URL) of a webpage in which the form is being filled in. In such an example, the input detection module 202 may further define the name of the data mark by appending a keyword, such as “idm” to the URL. In some embodiments, the name of the data mark is stored in a data structure as a primary key for the data mark. In one embodiment, the name of the data mark is stored in an extensible markup language (XML) file as the primary key. As may be appreciated, defining a name for the data mark and/or a URL associated with the data mark may facilitate automation of data entry into a form.

In some embodiments, the input detection module 202 creates a list of the input types that contain user input based on the detected input types and user input. In one embodiment, the list of input types may be formed based on detecting and including the names of objects on the form associated with an input control. In such embodiments, the list of corresponding user inputs may be formed by detecting and including the values corresponding to each object on the form associated with the input controls. In one embodiment, object properties may be detected to retrieve a property of the objects for differentiating between different objects. In such embodiments, the object properties may include label, text, or the like. For example, the label or text object properties may include information used to describe the detected input types.

The user selection module 204, in one embodiment, receives user selected input types that are to be stored in the data mark with their respective user inputs. In some embodiments, the user selection module 204 provides the detected input types and their respective user inputs to a user to enable the user to select input types, add input types, remove input types, edit input types, select user inputs, add user inputs, remove user inputs, and/or to edit user inputs. In such embodiments, the user selection module 204 may provide the input types and their respective user inputs to a display to facilitate selection, addition, removal, and/or editing.

The data mark creation module 206, in one embodiment, stores the data mark. In some embodiments, the data mark includes the user selected input types with their respective user inputs. In one embodiment, the data mark is stored in a data structure, such as an XML file. In certain embodiments, the names of objects associated with input controls may be saved in the data structure, in addition to corresponding values of the input controls. In some embodiments, an object property may be stored as part of the data mark. The object property may be object dependent, such as label, text, or the like. The data mark creation module 206 may, in some embodiments, store the data mark in a central repository to facilitate sharing the data mark with a team area or specific users. In certain embodiments, the data mark may be shared in a collaborative environment among multiple users and/or integrated into collaborative tools. In such an embodiment, the users may collaboratively use and/or edit the data mark, thereby facilitating updates to the data mark by users of the collaborative environment. Within such a collaborative environment, the data mark may be classified as private (e.g., if the data mark includes sensitive personal information) or public if the user wants to share the data mark with a team area or group.

FIG. 3 is a schematic block diagram illustrating one embodiment of another module 300 for creating a data mark. In one embodiment, the module 300 includes an embodiment of a data mark module 104. The data mark module 104, in various embodiments, includes one or more of an input detection module 202, a user selection module 204, and a data mark creation module 206, which may be substantially similar to the input detection module 202, the user selection module 204, and the data mark creation module 206 described above. The data mark module 104 may also include one or more of a security module 302, a data mark retrieval module 304, and a data population module 306, which are described in more detail below.

In one embodiment, the security module 302 validates user credentials for accessing the data mark. For example, the security module 302 may request that a username and a password be entered to authenticate a user attempting to retrieve the data mark. In certain embodiments, the security module 302 may facilitate associating a username and a password with each data mark in a group of data marks to enable access of the respective data mark by users. Accordingly, multiple users may access a data mark if they have the appropriate username and password. In some embodiments, a single username and password may be associated with a group of data marks. Moreover, in one embodiment, a network username and password may authenticate a user to data marks based on the user's inclusion in a group having access to the data marks.

The data mark retrieval module 304, in certain embodiments, retrieves the user inputs stored in the data mark for populating the user selected input types in a form of an application with the user inputs. In some embodiments, the data mark retrieval module 304 may coordinate with the security module 302 to ensure that the user has the appropriate credentials to access the data mark, such as by verifying the user's credentials prior to retrieving the user inputs stored in the data mark.

In one embodiment, the data population module 306 populates the user selected input types in the form of the application with their respective user inputs stored in the data mark. In some embodiments, the data population module 306 may coordinate with the data mark retrieval module 304 to obtain the data for populating the form. Moreover, the data population module 306, in certain embodiments, may compare the input types on the form with the selected input types in the data mark to ensure that the input types match. In some embodiments, by matching the selected input types in the data mark with the input types of the form, the user input may be populated into appropriate portions of the form.

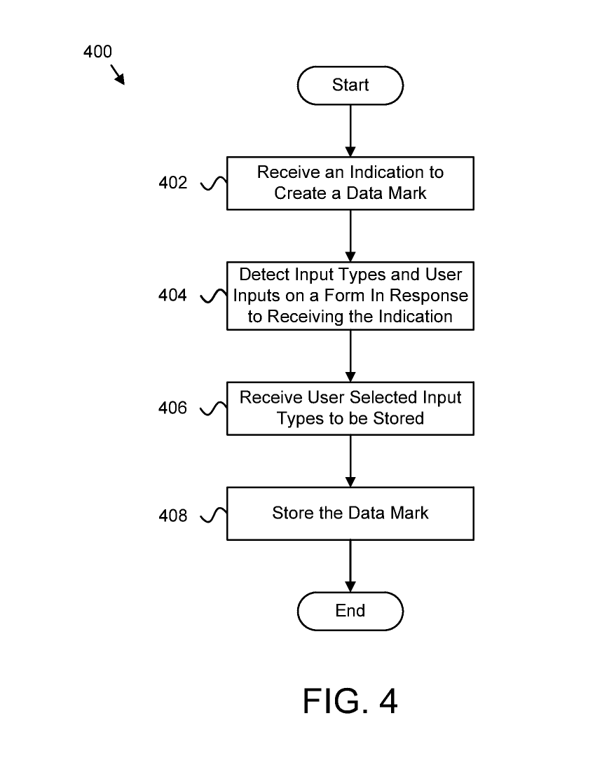

FIG. 4 is a schematic flow chart diagram illustrating one embodiment of a method 400 for creating a data mark. In one embodiment, the method 400 begins and the data mark module 104 receives 402 an indication to create a data mark corresponding to a form of an application. The input detection module 202, in certain embodiments, detects 404 input types and user inputs on the form of the application in response to receiving the indication to create the data mark. In some embodiments, each input type corresponds to a respective user input. In one embodiment, the user selection module 204 receives 406 user selected input types that are to be stored in the data mark with their respective user inputs. The data mark creation module 206, in certain embodiments, stores 408 the data mark including the user selected input types with their respective user inputs, and the method 400 ends.

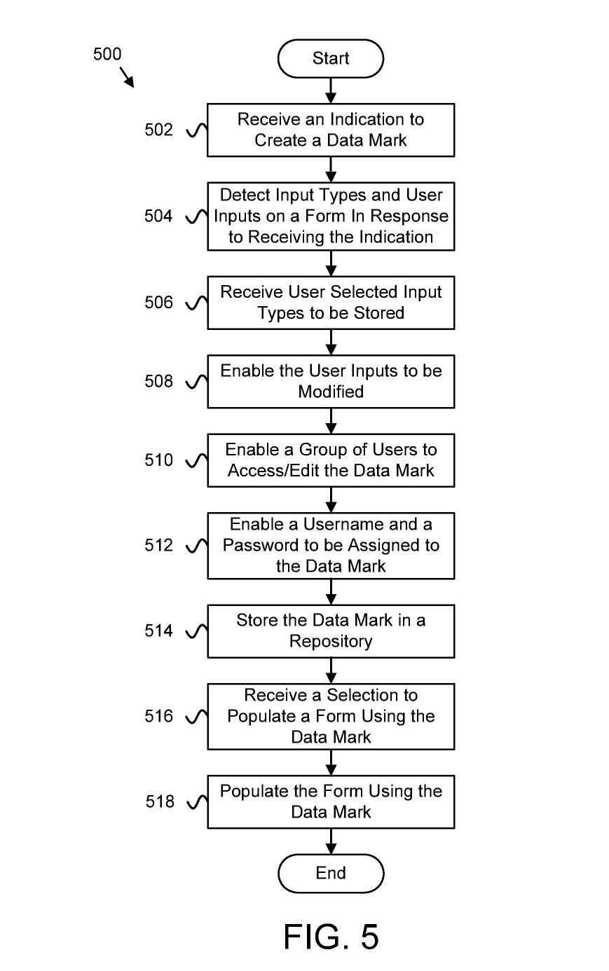

FIG. 5 is a schematic flow chart diagram illustrating one embodiment of another method 500 for creating a data mark. In one embodiment, the method 500 begins and the data mark module 104 receives 502 an indication to create a data mark corresponding to a form of an application. In some embodiments, the data mark module 104 receives 502 the indication to create the data mark corresponding to the form of a repetitive data entry application. The input detection module 202, in certain embodiments, detects 504 input types and user inputs on the form of the application in response to receiving the indication to create the data mark. In some embodiments, each input type corresponds to a respective user input. In one embodiment, the user selection module 204 receives 506 user selected input types that are to be stored in the data mark with their respective user inputs. The data mark creation module 206, in certain embodiments, enables 508 each user input to be selectively modified. Moreover, in one embodiment, the data mark creation module 206 enables removal of input types such that the removed input types and their respective user inputs are not stored in the data mark. Furthermore, in another embodiment, the data mark creation module 206 provides the input types that are to be stored in the data mark with their respective user inputs to a user to enable selection of the input types.

In some embodiments, the data mark creation module 206 enables 510 a group of users to be granted access to and/or to be granted permission to edit the data mark. Moreover, in certain embodiments, the data mark creation module 206 enables 512 a username and a password to be assigned to the data mark to facilitate accessing the data mark. The data mark creation module 206, in one embodiment, stores 514 the data mark including the user selected input types with their respective user inputs. The data mark creation module 206, in an embodiment, stores 514 the data mark in a central repository or database accessible by multiple users. In such an embodiment, the central repository or database may enable multiple users from different locations to access, import, and/or edit the saved data mark or multiple saved data marks. In certain embodiments, the data mark creation module 206 may store multiple data marks, with each data mark having a username and a password for accessing the respective data mark. In some embodiments, the data mark retrieval module 304 receives 516 a selection to populate the user selected input types in the form of the application with their respective user inputs stored in the data mark. The data population module 306, in certain embodiments, populates 518 the user selected input types in the form of the application with their respective user inputs stored in the data mark in response to the selection to populate the user selected input types, and the method 500 ends.

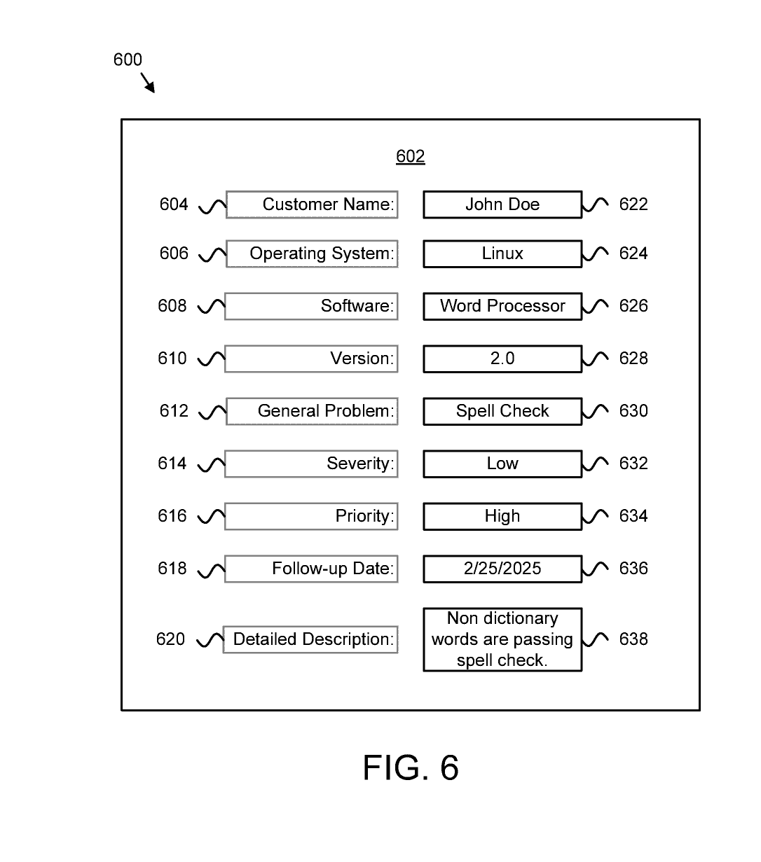

FIG. 6 illustrates one embodiment of an application 600 for creating a data mark. In some embodiments, the application 600 includes a form 602. The form 602, in certain embodiments, includes multiple input types 604, 606, 608, 610, 612, 614, 616, 618, and 620 (e.g., fields). Furthermore, in one embodiment, the form 602 includes multiple user inputs 622, 624, 626, 628, 630, 632, 634, 636, and 638 each corresponding to a respective input type 604, 606, 608, 610, 612, 614, 616, 618, and 620. In some embodiments, the form 602 represents a form that is repetitively filled out. Thus, creating a data mark to fill out the form 602 may facilitate saving time entering data into the form 602.

In certain embodiments, some of the data used to fill out the form 602 may be the same for multiple times that the form 602 is filled out. For example, the input types 606, 608, 610, 612, 614, and 616 may be the same for multiple times the form 602 is filled out. In contrast, the input types 604, 618, and 620 may be different for most times the form 602 is filled out. Accordingly, in such an embodiment, a data mark may be created that includes the user inputs 624, 626, 628, 630, 632, and 634 that correspond to the input types 606, 608, 610, 612, 614, and 616.

In some embodiments, a user may provide an indication to the input detection module 202 to create a data mark corresponding to the form 602. In one embodiment, the input detection module 202 may detect the input types 604, 606, 608, 610, 612, 614, 616, 618, and 620 and the user inputs 622, 624, 626, 628, 630, 632, 634, 636, and 638. In another embodiment, the user selection module 204 may receive user selected input types that are to be stored in the data mark with their respective user inputs, such as the input types 606, 608, 610, 612, 614, and 616 and their respective user inputs 624, 626, 628, 630, 632, and 634. In some embodiments, the data mark creation module 206 may store the user selected input types with their respective user inputs.

In some embodiments, the data mark may also be used to fill in the form 602 before the form 602 is populated with the user inputs 622, 624, 626, 628, 630, 632, 634, 636, and 638. For example, a user may open a browser or application that includes the form 602. The security module 302 may validate the user's credentials and retrieve data marks available to the user. The user may select a desired data mark and the data mark retrieval module 304 may retrieve the selected data mark. Moreover, the data population module 306 may populate the form 602 with saved user inputs, such as the user inputs 624, 626, 628, 630, 632, and 634. In this manner, the data mark may be used to populate a form, such as a form that is repetitively populated with the same information.

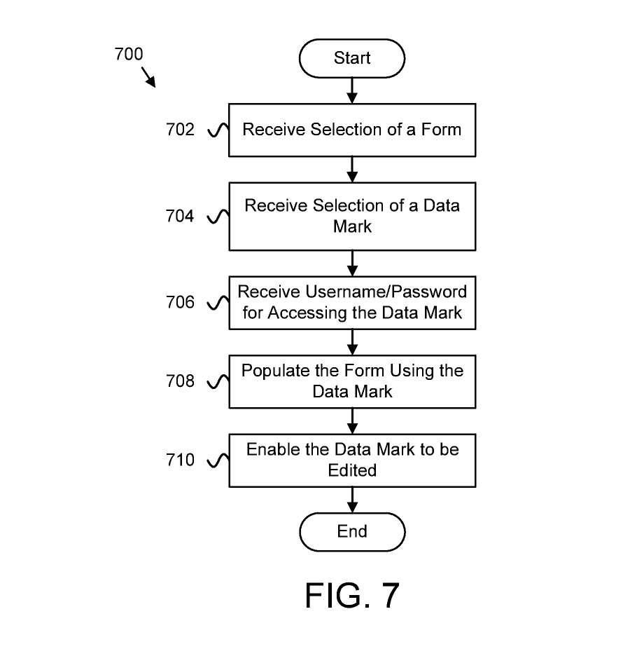

FIG. 7 is a schematic flow chart diagram illustrating one embodiment of a method 700 for populating a form, such as the form 602, using a data mark in accordance with one embodiment of the present invention. In one embodiment, the method 700 begins and receives 702 a selection of a form of an application to be populated using a data mark, such as a form on a website selected through a browser. For example, a user may navigate using a browser to a website having the form. In some embodiments, the user may navigate to the website by selecting a bookmark, a shortcut, or a data mark that contains the URL for the desired form. With such a selection, the browser may navigate directly to the URL after the bookmark, the shortcut, or the data mark is selected. In some embodiments, the method 700 may receive 704 a selection of a data mark separate from a selection of the form; however, in other embodiments the selection of the data mark may occur at the same time as the selection of the form, such as when the form is selected by selecting the data mark. In some embodiments, the data mark retrieval module 304 may receive 704 the selection of the data mark.

In certain embodiments, the method 700 receives 706 a username and/or a password for accessing the data mark. In an embodiment, the security module 302 may be used to receive 706 the username and/or the password for accessing the data mark. Furthermore, the security module 302 may verify that the username and/or the password for accessing the data mark are correct. In some embodiments, the method 700 populates 708 the form using the data mark. As may be appreciated, the data population module 306 may facilitate populating 708 the form using the data mark. In one embodiment, the method 700 enables 710 the data mark to be edited, then the method 700 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an input detection module that detects a plurality of input types and a plurality of user inputs on a form of an application in response to receiving an indication to create a data mark, wherein each input type of the plurality of input types corresponds to a respective user input of the plurality of user inputs;
a user selection module that receives user selected input types of the plurality of input types that are to be stored in the data mark with their respective user inputs of the plurality of user inputs; and
a data mark creation module that stores the data mark comprising the user selected input types of the plurality of input types with their respective user inputs,
wherein at least a portion of the input detection module, the user selection module, and the data mark creation module comprise one or more of hardware and executable code, the executable code stored on one or more computer readable storage media.

2. The apparatus of claim 1, further comprising a security module that validates user credentials for accessing the data mark.

3. The apparatus of claim 1, further comprising a data mark retrieval module that retrieves the user inputs stored in the data mark for populating the user selected input types in the form of the application with the user inputs.

4. The apparatus of claim 1, further comprising a data population module that populates the user selected input types of the plurality of input types in the form of the application with their respective user inputs stored in the data mark.

5. A method for creating a data mark comprising:
receiving an indication to create a data mark corresponding to a form of an application;
detecting a plurality of input types and a plurality of user inputs on the form of the application in response to receiving the indication to create the data mark, wherein each input type of the plurality of input types corresponds to a respective user input of the plurality of user inputs;
receiving user selected input types of the plurality of input types that are to be stored in the data mark with their respective user inputs of the plurality of user inputs; and
storing the data mark comprising the user selected input types of the plurality of input types with their respective user inputs.

6. The method of claim 5, further comprising enabling each user input of the plurality of user inputs to be selectively modified.

7. The method of claim 5, further comprising enabling a group of users to be granted access to the data mark.

8. The method of claim 5, further comprising enabling a group of users to be granted permission to edit the data mark.

9. The method of claim 5, further comprising enabling a username and a password to be assigned to the data mark to facilitate accessing the data mark.

10. The method of claim 5, further comprising storing a plurality of data marks, each data mark of the plurality of data marks comprising a username and a password for accessing the respective data mark.

11. The method of claim 5, wherein receiving the indication to create the data mark corresponding to the form of the application further comprises receiving the indication to create the data mark corresponding to the form of a repetitive data entry application.

12. The method of claim 5, wherein storing the data mark further comprises storing the data mark in a repository accessible by a plurality of users.

13. The method of claim 5, further comprising receiving a selection to populate the user selected input types of the plurality of input types in the form of the application with their respective user inputs stored in the data mark.

14. The method of claim 13, further comprising populating the user selected input types of the plurality of input types in the form of the application with their respective user inputs stored in the data mark in response to the selection to populate the user selected input types.

15. The method of claim 5, wherein receiving user selected input types of the plurality of input types that are to be stored in the data mark further comprises enabling removal of input types of the plurality of input types such that the removed input types of the plurality of input types and their respective user inputs of the plurality of user inputs are not stored in the data mark.

16. The method of claim 5, further comprising providing the input types of the plurality of input types that are to be stored in the data mark with their respective user inputs of the plurality of user inputs to a user to enable selection of the input types.

17. A computer program product for creating a data mark, the computer program product comprising a computer readable storage medium having program instructions embodied therewith, the program instructions readable/executable by a processor to cause the processor to:
receive, by processor, an indication to create a data mark corresponding to a form of an application;
detect, by processor, a plurality of input types and a plurality of user inputs on the form of the application in response to receiving the indication to create the data mark, wherein each input type of the plurality of input types corresponds to a respective user input of the plurality of user inputs;
receive, by processor, user selected input types of the plurality of input types that are to be stored in the data mark with their respective user inputs of the plurality of user inputs; and
store, by processor, the data mark comprising the user selected input types of the plurality of input types with their respective user inputs.

18. The computer program product of claim 17, the program instructions further causing the processor to enable a group of users to be granted access to the data mark.

19. The computer program product of claim 17, the program instructions further causing the processor to enable a username and a password to be assigned to the data mark to facilitate accessing the data mark.

20. The computer program product of claim 17, wherein the program instructions that cause the processor to store the data mark further cause the processor to store the data mark in a repository accessible by a plurality of users.
